(19) United States
(12) Patent Application Publication
(10) Pub. No.: US 2011/0033174 A1
(43) Pub. Date: Feb. 10, 2011

(54) CONTROL CIRCUIT FOR A VARIABLE FREQUENCY DC MOTOR

(75) Inventors: Ko-Yen Lee, Hsin-Chu City (TW); Chang-Ling Sha, Hsin-Chu City (TW)

Correspondence Address: APEX JURIS, PLLC, 12733 LAKE CITY WAY NORTHEAST, SEATTLE, WA, 98125, US

(73) Assignee: GRENERGY OPTO, INC., Hsin-Chu City (TW)

(21) Appl. No.: 12/536,701

(22) Filed: Aug. 6, 2009

(51) Int. Cl. G05F 1/10

(52) U.S. Cl. 388/806

(57) ABSTRACT

The present invention discloses a control circuit for a variable frequency DC motor, the control circuit comprising: a controller, having a voltage sensing input end and a control output end, wherein the control output end is used to deliver an output signal according to the difference between a threshold voltage and the voltage at the voltage sensing input end; a transistor, having a first terminal, a second terminal and a third terminal, wherein the first terminal is coupled to the voltage sensing input end, and the second terminal is coupled to the variable frequency DC motor, and the third terminal is coupled to a reference ground; and a voltage divider, coupled between the second terminal and the third terminal, used to generate a feedback voltage for the voltage sensing input end; wherein the voltage at the second terminal is regulated according to the threshold voltage.

### BACKGROUND OF THE INVENTION

1. Field of the Invention

The present invention relates to motor control circuits, and more particularly to a control circuit for a variable frequency DC motor.

2. Description of the Related Art

In supplying power to a variable frequency DC motor, a control circuit is needed to keep the rotation speed of the variable frequency DC motor stable. The variable frequency DC motor, for example implemented in a fan, can operate with different switching frequencies according to different rotation speed requirements. Please refer to FIG. 1, which shows the architecture of a prior art voltage control circuit for a variable frequency DC motor. As shown in FIG. 1, the prior art voltage control circuit comprises a controller 101, a resistor 102, a thermal resistor 103, a resistor 104, a transistor 105 and a variable frequency DC motor 106.

In the architecture, the controller 101 comprises a reference voltage output end, a threshold voltage input end, a driving output end and a voltage sensing input end, wherein the reference voltage output end is used to provide a reference voltage V_{ref}, and the driving output end is used to generate a driving signal V_{G} according to the difference between a threshold voltage Vₜₕ at the threshold voltage input end and a sensing voltage Vₛₑₙ at the voltage sensing input end.

The resistor 102 is connected between the reference voltage output end and the threshold voltage input end, and the thermal resistor 103 is connected between the threshold voltage input end and a reference ground. The threshold voltage Vₜₕ is generated according to a voltage division formula: Vₜₕ=V_{ref}×(the resistance of the thermal resistor 103)/(the resistance of the resistor 102+the resistance of the thermal resistor 103), wherein the resistance of the thermal resistor 103 is a function of temperature, so that the threshold voltage Vₜₕ will vary with temperature.

The resistor 104, connected between the controller 101 and the transistor 105, is used to limit the base current of the transistor 105. The transistor 105, having a base terminal connected to the resistor 104, a collector terminal connected to a DC voltage V_{dc} and an emitter terminal connected to the voltage sensing end, is used to operate in an active region to provide the sensing voltage Vₛₑₙ as a supply voltage for the variable frequency DC motor 106.

The variable frequency DC motor 106 has an equivalent circuit as shown in FIG. 3. The equivalent circuit comprises a resistor 301, a capacitor 302 and switches 303˜306. The resistor 301 and the capacitor 302 are used to supply a current I_{C} to add with a current I_{DC} to generate a current I_{M} for a motor M. The switches 303˜306 are used to provide alternative driving paths for the supply voltage to drive the motor M, and the rotation speed of the motor M will be increased if the supply voltage is raised up. Since the sensing voltage Vₛₑₙ, served as the supply voltage, is derived by subtracting a voltage dropt across the transistor 105 from the DC voltage V_{dc}, and the voltage dropt across the transistor 105 in the active region actually occupies quite a portion of the DC voltage V_{dc}, the highest level of the supply voltage of the variable frequency DC motor 106 is therefore limited and so is the rotation speed.

To increase the highest level of the supply voltage of the variable frequency DC motor 106, a prior art current control circuit is proposed. Please refer to FIG. 2, which shows the architecture of a prior art current control circuit for a variable frequency DC motor. As shown in FIG. 2, the prior art current control circuit comprises a controller 201, a resistor 202, a thermal resistor 203, a resistor 204, a transistor 205, a resistor 206 and a variable frequency DC motor 106.

In the architecture, the controller 201 comprises a reference voltage output end, a threshold voltage input end, a driving output end and a current sensing input end, wherein the reference voltage output end is used to provide a reference voltage V_{ref}, and the driving output end is used to generate a driving signal V_{G} according to the difference between a threshold voltage Vₜₕ at the threshold voltage input end and a current sensing signal Iₛₑₙ at the current sensing input end.

The resistor 202 is connected between the reference voltage output end and the threshold voltage input end, and the thermal resistor 203 is connected between the threshold voltage input end and a reference ground. The threshold voltage Vₜₕ is generated according to a voltage division formula: Vₜₕ=V_{ref}×(the resistance of the thermal resistor 203)/(the resistance of the resistor 202+the resistance of the thermal resistor 203), wherein the resistance of the thermal resistor 203 is a function of temperature, so that the threshold voltage Vₜₕ will vary with temperature.

The resistor 204, connected between the controller 201 and the transistor 205, is used to limit the base current of the transistor 205. The transistor 205, having a base terminal connected to the resistor 204, a collector terminal connected to the negative terminal of the variable frequency DC motor 106 and an emitter terminal connected to the current sensing end, is used to provide a driving current for the variable frequency DC motor 106. The resistor 206 is used to carry the driving current to exhibit the current sensing signal Iₛₑₙ.

The variable frequency DC motor 106, connected between a DC voltage and the collector terminal, is driven by the driving current. According to the equivalent circuit shown in FIG. 3, a driving current I_{DC} is added with a current I_{C} to generate a current I_{M} for a motor M. When the switches 303˜306 are switching with a frequency, the current I_{M} and the current I_{C} will exhibit periodic waveforms shown in FIG. 4. Although the driving current I_{DC} is regulated by the current control circuit to a DC level, the voltage between the positive terminal and the negative terminal will be varying due to the current I_{C} flowing through the resistor 301, and this will cause the rotation speed of the motor M unstable.

Therefore, there is a need to provide a solution capable of increasing the supply voltage of a DC motor and keeping the supply voltage stable as well.

Seeing this bottleneck, the present invention proposes a novel topology of a control circuit for a variable frequency DC motor.

### SUMMARY OF THE INVENTION

One objective of the present invention is to provide a control circuit for a variable frequency DC motor to operate in a wide bias voltage range.

Another objective of the present invention is to provide a control circuit for a variable frequency DC motor to operate in a stable manner.

Still another objective of the present invention is to provide a control circuit for a variable frequency DC motor to operate adaptively in response to temperature.

To achieve the foregoing objectives, the present invention provides a control circuit for a variable frequency DC motor, wherein the variable frequency DC motor has a positive terminal coupled to a DC supply voltage and a negative terminal coupled to the control circuit, the control circuit comprising: a controller, having a voltage sensing input end and a control output end, wherein the control output end is used to deliver an output signal according to the voltage difference between a threshold voltage and the voltage at the voltage sensing input end; a transistor, having a first terminal, a second terminal and a third terminal, wherein the first terminal is coupled to the voltage sensing input end, and the second terminal is coupled to the negative terminal of the variable frequency DC motor, and the third terminal is coupled to a reference ground; and a voltage divider, coupled between the second terminal and the third terminal, used to generate a divided voltage of the voltage at the second terminal to couple to the voltage sensing input end; wherein the voltage at the second terminal is regulated according to the threshold voltage.

To make it easier for our examiner to understand the objective of the invention, its structure, innovative features, and performance, we use a preferred embodiment together with the accompanying drawings for the detailed description of the invention.

### BRIEF DESCRIPTION OF THE DRAWINGS

FIG. 1 is the architecture of a prior art voltage control circuit for a variable frequency DC motor.

FIG. 2 is the architecture of a prior art current control circuit for a variable frequency DC motor.

FIG. 3 is the circuit model for a variable frequency DC motor.

FIG. 4 is the current waveforms of I_{DC}, I_{C} and I_{M} for the circuit model in FIG. 3 when I_{DC} is constant.

FIG. 5 is a control circuit for a variable frequency DC motor according to a preferred embodiment of the present invention.

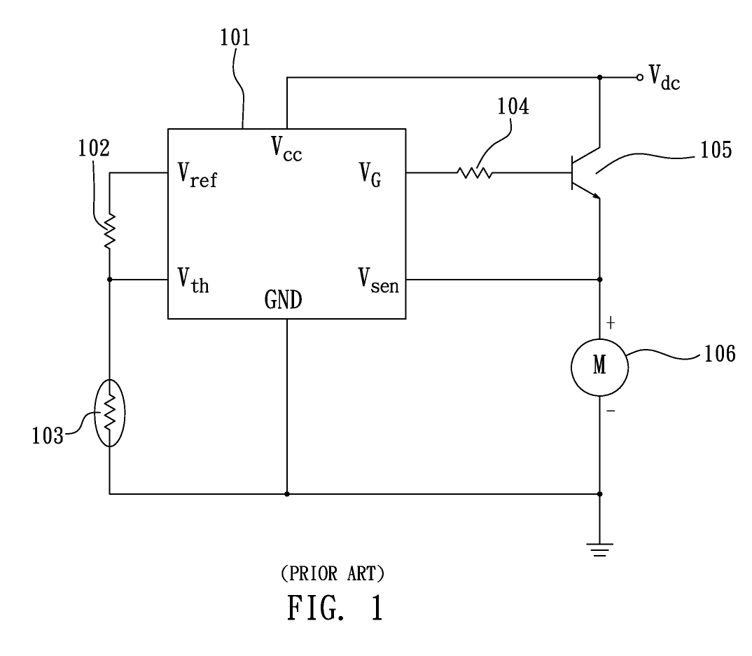

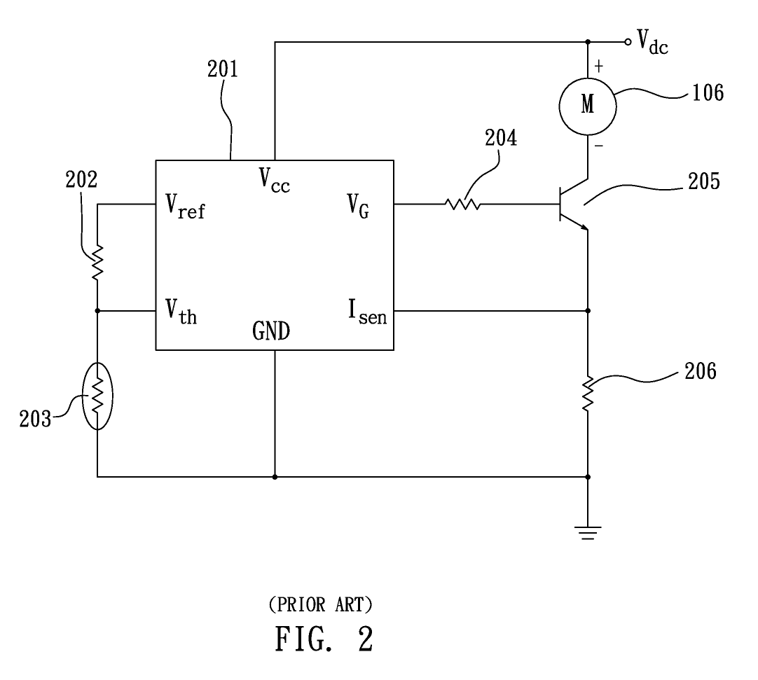

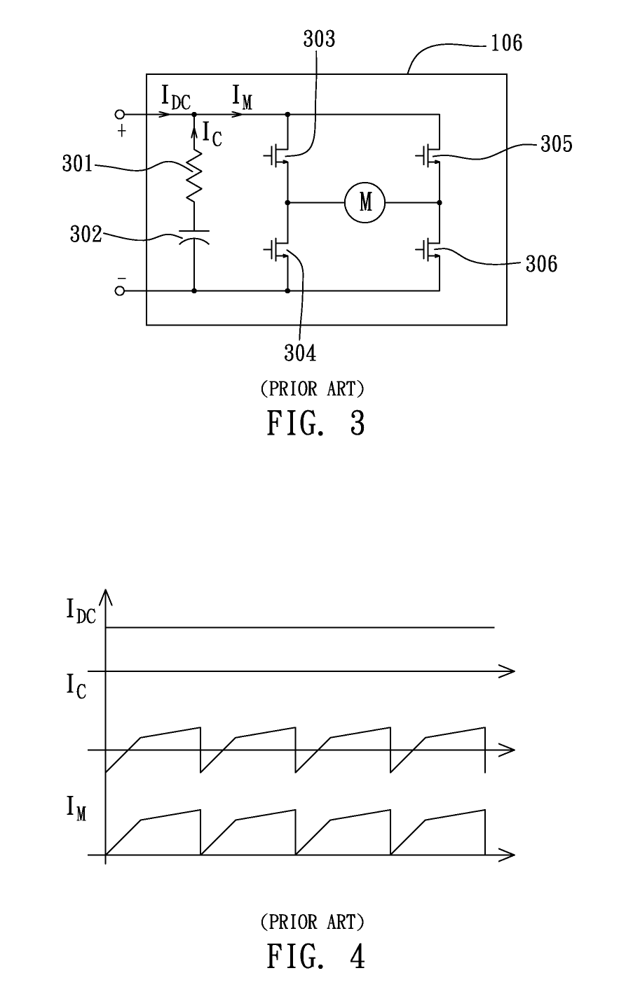

### DETAILED DESCRIPTION OF THE PREFERRED EMBODIMENTS

The present invention will be described in more detail hereinafter with reference to the accompanying drawings that show the preferred embodiment of the invention.

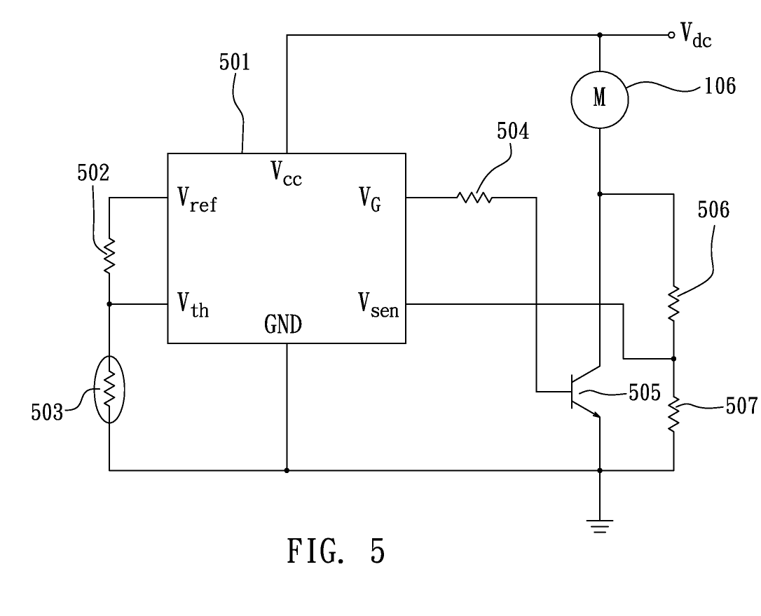

Please refer to FIG. 5, which shows a control circuit for a variable frequency DC motor according to a preferred embodiment of the present invention. As shown in FIG. 5, the control circuit for a variable frequency DC motor comprises a controller 501, a resistor 502, a thermal resistor 503, a resistor 504, a transistor 505, two dividing resistors 506˜507 and a variable frequency DC motor 106.

In the architecture, the controller 501 comprises a reference voltage output end, a threshold voltage input end, a driving output end and a voltage sensing input end, wherein the reference voltage output end is used to provide a reference voltage V_{ref}, and the driving output end is used to generate a driving signal V_{G} according to the difference between a threshold voltage Vₜₕ at the threshold voltage input end and a sensing voltage Vₛₑₙ at the voltage sensing input end.

The resistor 502 is connected between the reference voltage output end and the threshold voltage input end, and the thermal resistor 503 is connected between the threshold voltage input end and a reference ground. The threshold voltage Vₜₕ is generated according to a voltage division formula: Vₜₕ=V_{ref}×(the resistance of the thermal resistor 503)/(the resistance of the resistor 502+the resistance of the thermal resistor 503), wherein the resistance of the thermal resistor 503 is a function of temperature, so that the threshold voltage Vₜₕ will vary with temperature.

The resistor 504, connected between the controller 501 and the transistor 505, is used to limit the base current of the transistor 505. The transistor 505, having a base terminal connected to the resistor 504, a collector terminal connected to the variable frequency DC motor 106 and an emitter terminal connected to a reference ground, is used to provide a collector voltage to bias the variable frequency DC motor 106. The transistor 505 can operate in an active region or a saturation region and the collector voltage can be as low as ˜0.1 V.

The two dividing resistors 506˜507 connected between the collector terminal and the emitter terminal of the transistor 505, are used to provide a sensing voltage Vₛₑₙ, which is proportional to the collector voltage of the transistor 505, for the voltage sensing input end of the controller 501. Through a negative feedback operation of the architecture, the collector voltage of the transistor 505 is regulated according to the threshold voltage Vₜₕ so that the difference between the sensing voltage Vₛₑₙ and the threshold voltage Vₜₕ is approaching zero.

The variable frequency DC motor 106, connected between a DC voltage V_{dc} and the collector terminal, is driven by the voltage difference between the DC voltage V_{dc} and the collector voltage. As the sensing voltage Vₛₑₙ is derived from a divided voltage of the collector voltage and the emitter terminal of the transistor 505 is connected to the reference ground, the collector voltage can be controlled to a very low voltage and the variable frequency DC motor 106 can therefore stably operate in a wider range of bias voltage than in the prior art.

Through the implementation of the present invention, a novel control circuit for a variable frequency DC motor is presented. The topology of the present invention can provide a stable and wide range of bias voltage for the variable frequency DC motor, so it does conquer the disadvantages of prior art circuits.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance than the conventional structure and further complies with the patent application requirements and is submitted to the Patent and Trademark Office for review and granting of the commensurate patent rights.

What is claimed is:

1. A control circuit for a variable frequency DC motor, wherein said variable frequency DC motor has a positive terminal coupled to a DC supply voltage and a negative terminal coupled to said control circuit, said control circuit comprising:
a controller, having a voltage sensing input end and a control output end, wherein said control output end is used to deliver an output signal according to the voltage difference between a threshold voltage and the voltage at said voltage sensing input end;
a transistor, having a first terminal, a second terminal and a third terminal, wherein said first terminal is coupled to said voltage sensing input end, and said second terminal is coupled to said negative terminal of said variable frequency DC motor, and said third terminal is coupled to a reference ground; and
a voltage divider, coupled between said second terminal and said third terminal, used to generate a divided voltage of the voltage at said second terminal to couple to said voltage sensing input end;
wherein the voltage at said second terminal is regulated according to said threshold voltage.

2. The control circuit for a variable frequency DC motor as claim 1, wherein said controller further comprises:
a reference output end, used to generate a reference voltage; and
a threshold voltage input end, used for setting said threshold voltage.

3. The control circuit for a variable frequency DC motor as claim 2, further comprising:
a first resistor, connected between said reference output end and said threshold voltage input end; and
a thermal resistor, connected between said threshold voltage input end and said reference ground.

4. The control circuit for a variable frequency DC motor as claim 3, further comprising a second resistor, which is connected between said control output end and said first terminal.

5. The control circuit for a variable frequency DC motor as claim 1, wherein said voltage divider comprises:
a third resistor, connected between said second terminal and said voltage sensing input end; and
a fourth resistor, connected between said voltage sensing input end and said reference ground.
